(19) United States
(12) Patent Application Publication
(10) Pub. No.: US 2011/0135425 A1
(43) Pub. Date: Jun. 9, 2011

(54) CHARGING INSTALLATION FOR A SHAFT FURNACE AND LOWER SEALING VALVE ASSEMBLY THEREFORE

(75) Inventors: Guy Thillen, Diekirch (LU); Ettore Rizzuti, Bascharage (LU); Jeff Vandivinit, Dalheim (LU); Jeannot Loutsch, Mondercange (LU)

(73) Assignee: PAUL WURTH S.A., Luxembourg (LU)

(21) Appl. No.: 13/058,135

(22) PCT Filed: Jul. 30, 2009
(86) PCT No.: PCT/EP2009/059890

§ 371 Date: Feb. 8, 2011

(30) Foreign Application Priority Data
Aug. 8, 2008 (LU) 91469

(51) Int. Cl. F27B 1/20; F16K 25/00

(52) U.S. Cl. 414/199; 251/205

(57) ABSTRACT

The invention concerns a charging installation for a shaft furnace, in particular for a blast furnace, and especially the lower sealing valve assembly thereof, the installation including at least two hoppers acting as lock hoppers for intermediate storage of charge material to be charged into the furnace, the lower sealing valve includes a lower sealing valve housing arranged below the hoppers, the lower sealing valve housing has at least two inlets respectively communicating with one of the hoppers and an outlet for passing charge material into the furnace, each inlet has a respective associated valve seat providing gas-tight sealing of the hoppers downstream, the lower sealing valve assembly further includes a sealing valve mechanism for sealing the inlets, more specifically for closing the seats in technically gas-tight manner, where the sealing valve mechanism includes a one-sided shutter having a single sealing face that cooperates with both of the at least two valve seats, by virtue of the sealing valve mechanism being configured to bring the sealing face of the one-sided shutter into sealing contact in turn with each of the at least two valve seats for sealing the associated inlet.

### TECHNICAL FIELD

The present invention generally relates to a charging installation for a shaft furnace, especially a top charging installation for a blast furnace, and more particularly to a lower sealing valve assembly for this type of charging installation.

### BACKGROUND

Charging installations of the Bell Less Top™ type developed by PAUL WURTH have found widespread use in blast furnaces throughout the world. In these installations, one ore more hoppers, which are used for intermediate storage of charge material to be charged into the pressurized furnace, serve as a sluice or lock chamber to avoid loss of furnace pressure. To this effect, a first valve, commonly called upper sealing valve or upper seal valve, is associated to the hopper inlet and a second sealing valve, commonly called lower sealing valve or lower seal valve, is associated to the outlet of the hopper. The upper and lower valves are opened and closed in alternation as in a gas lock or sluice chamber to avoid that gas escapes through a hopper. The present invention relates to providing the lower sealing valve function, especially in a multiple hopper installation of the above type in which one hopper is being filled while the other is being emptied. Although particularly suitable for a BLT™ system, the proposed lower sealing valve assembly can also be used in similar competitors' systems.

FIG. 14 shows a prior art blast furnace charging installation with two lock hoppers as disclosed in International patent application WO 2007/082630. This installation comprises a lower sealing valve housing 1 that has two upper inlets 2,4 communicating with either of two hoppers 22,24 (only the lowermost part of which is shown). The housing 1 is arranged to deflect charge material received through an inlet 2,4 from a respective hopper 22, 24 to a central lower outlet 7 that is coaxial to the furnace axis 5. The lower outlet 7 communicates with the furnace throat via a central feeder spout to feed material to a distribution device (not shown) arranged below the housing 1. Charge material is metered by means of material gate valves 26, 28 respectively arranged in between each of the outlets of the hoppers 22, 24 and each of the inlets 2, 4 of the lower sealing valve assembly.

In order to provide the sealing function required to avoid loss of furnace gas pressure, each inlet 2, 4 of the lower sealing valve housing 1 has an associated valve seat 12, 14 that cooperates with a dedicated flap type valve pivoting mechanism. Each flap type valve mechanism comprises a dedicated shutter in the form of sealing valve flaps 32, 34. Each sealing valve flap 32, 34 further has a respective flap arm 36, 38 on which it is mounted to move between an engaged sealing position on its associated seat 12, 14 (see valve flap 34 on seat 14 in FIG. 14) and an open position, in which it does not have a sealing function (see valve flap 32 and open inlet 2 in FIG. 14), to allow charging material into the furnace. For each sealing valve flap 32, 34, an individual dedicated pivoting actuator is supported on either side of the housing 1 and operatively connected to the corresponding flap arm 36, 38 for moving the respective sealing valve flap 32, 34 into and out of sealing contact with the associated valve seat 12, 14. Due to dedicated actuators and separately pivotable arms, each sealing valve flap can be closed or opened independently of the other sealing valve flap to enable shorter charging cycle times, since charging of a hopper communicating with a closed lower sealing valve may continue during the transition of another lower sealing valve from open to closed position. Lower sealing valve assemblies for multiple-hopper installations of the BLT™ type, which use a dedicated shutter and corresponding actuation mechanism for each inlet, are known since decades as evidenced e.g. by early U.S. Pat. No. 3,955,693. They have since the beginnings found successful and widespread application in iron making industry.

A more recent and unusual type of two-hopper charging installation has been disclosed in International patent application WO 01/00884. The installation also comprises a lower sealing valve housing arranged below two intermediate storage hoppers that act as locks. In known manner, the housing has two inlets, each inlet having a respective associated valve seat and communicating with one of the hoppers respectively, and an outlet for passing charge material into the furnace. The sealing valve mechanism for sealing the inlets, i.e. for providing the downstream gas-tight closure of the lock hoppers, has an uncommon configuration. In fact, the sealing valve mechanism comprises a double-sided sealing valve flap that is mounted pivotally on an arm. The double-sided sealing valve flap according to WO 01/00884 has a seal on either side, a first sealing face cooperating with a first of the two valve seats, whereas the other second sealing face of the valve flap cooperates with the second of the two valve seats.

Whereas the lower sealing valve assembly according to WO 01/00884 enables the use of a single actuator arrangement for sealing both inlets, it presents the drawback of increasing the cycle time requiring a longer interval for refilling a hopper. In fact, both upper sealing valves have to be closed during motion of the double-sided lower sealing valve flap from the first seat to the second seat in order to avoid pressure loss. Furthermore, it also presents another drawback of any typical lower sealing valve according to the prior art, such as disclosed in U.S. Pat. No. 3,955,693. That is to say, the sealing face of a shutter and in particular the seal thereon, is exposed to severely adverse conditions, among others due to high furnace temperature and a dust laden environment created by the closely passing bulk material, every time the associated inlet is open for charging purposes.

### BRIEF SUMMARY

The invention proposes a multiple-hopper charging installation for a shaft furnace, especially for a blast furnace, that reduces exposure of the sealing face of a shutter in the lower sealing valve assembly.

The invention more particularly proposes a top charging installation, equipped with a lower sealing valve assembly. Three-hopper type charging installations are also provided. The term assembly in the present context is to mean a device comprised of a number of component parts fitted together to form a functional unit.

A proposed charging installation comprises at least two hoppers acting as lock hoppers for intermediate storage of charge material to be charged into the furnace and a lower sealing valve assembly. This assembly includes a lower sealing valve housing arranged below the hoppers. The lower sealing valve housing has at least two inlets respectively communicating with one of the hoppers and an outlet for passing charge material into the furnace. Each inlet has a respective associated valve seat for the downstream gas tight sealing of the hoppers in view of their gas lock (gas sluice) function in cooperation with the upstream upper sealing valves of the hoppers. The lower sealing valve assembly further includes a sealing valve mechanism for sealing the inlets, more specifically for closing the seats in technically gas-tight manner.

According to the invention, the sealing valve mechanism comprises a one-sided shutter having a single sealing face that cooperates with both of the at least two valve seats. To this effect, the sealing valve mechanism is configured to bring the sealing face of the one-sided shutter into sealing contact in turn with each of the at least two valve seats for sealing the associated inlet. In other words, the same sealing face of the same single shutter is used on two different valve seats for sealing the associated inlets. Sealing face in the present context is to mean the surface(s) of the shutter brought into sealing contact with a seat, which is typically the side of the shutter that bears one or more seals or gaskets for gas-tight engagement on the seats.

As will be appreciated, a particular advantageous effect of the present invention resides in a substantial reduction of the exposure of the shutter sealing face and especially the seal to any detrimental conditions inside the lower sealing valve housing. In fact, using only one single-sided shutter for alternatively sealing more than one inlet has the benefit that, except for the comparatively short transition time required for moving the shutter between the seats, the shutter sealing face is always engaged on a given seat and thereby protected, while the other seat and associated inlet is open to allow charging material.

According to a first variant, the sealing valve mechanism is configured for translating the shutter up and down in substantially vertical direction along a joint axis and swiveling the shutter in a substantially horizontal plane perpendicular to the joint axis to allow bringing the same sealing face into sealing contact in turn with each of the at least two valve seats. In a preferred execution of this variant, the mechanism comprises a turn-slide cylindric joint having a substantially vertical joint axis and an extension arm having a first end portion and a second end portion. The shutter is mounted on the first end portion of the extension arm and the turn-slide cylindric joint supports the extension arm at the second end portion.

According to a second variant, the sealing valve mechanism comprises a revolute joint having a substantially vertical joint axis, an extension arm having a first part and a second part, the shutter being mounted on the first part and the revolute joint supporting the second part of the extension. A hinge having a substantially horizontal hinge axis connects the first part to the second part. This variant is configured for swiveling the extension arm with the shutter in a substantially horizontal plane perpendicular to the joint axis and pivoting the first part with the shutter up and down about a substantially horizontal hinge axis to allow bringing the same sealing face into sealing contact in turn with each of the at least two valve seats. The preceding variants have the additional benefit of reducing the vertical height required for the sealing valve mechanism and thereby reducing the total height of the charging installation.

According to a third variant, the sealing valve mechanism comprises a revolute joint that has a substantially horizontal joint axis (instead of vertical) and supports an extension arm that has a first part and a second part, the shutter being mounted on the first part and the revolute joint supporting the second part of the extension arm. A hinge having a hinge axis arranged transversely to the joint axis connects the first part to the second part. This variant enables swiveling the extension arm with the shutter about the horizontal joint axis and pivoting the first part with the shutter up and down about the transverse hinge axis to bring the same sealing face into sealing contact in turn with each of the at least two valve seats.

To enable simple swiveling mechanics, the sealing valve mechanism is supported by the lower sealing valve housing with the joint axis being contained in the perpendicular bisecting plane of two valve seats, with which the sealing face can be brought in turn into sealing contact.

In case of the first or second variant, the sealing valve mechanism is preferably supported by the top side of the lower sealing valve housing the housing with the substantially vertical joint axis laterally offset from the segment connecting the respective centers of the first valve seat and the second valve seat. In case of the third variant, the said sealing valve mechanism is preferably supported by a side wall of said lower sealing valve housing with said substantially horizontal joint axis vertically offset below the segment connecting the respective centers of said first valve seat and said second valve seat. With sufficient offset, the required angular travel for swiveling maybe substantially reduced and actuation accordingly simplified. Irrespectively of the chosen variant, wherein the shutter is preferably mounted on said the end portion of the extension arm by means of a globe joint to allow for certain misalignments e.g. due to temperature induced deformations or to allow for slightly inclined seat arrangement.

A three-hopper charging installation employing the underlying concept of using a given shutter for sealing more than one valve seat is proposed herein. This installation is characterized in that the sealing valve mechanism comprises a first one-sided shutter having a single sealing face and a second one-sided shutter having a single sealing face, wherein each shutter cooperates with all of the three valve seats, two seats being closed simultaneously at a time by the shutters. In other words, the sealing valve mechanism is configured to bring the sealing face of the first shutter and the sealing face of the second shutter respectively in paired manner into sealing contact in turn with the first and second valve seats, with the second and third valve seats and with the third and first valve seats so as to allow sealing two of the three inlets at a time

A three-hopper charging installation employing the underlying concept in another approach that allows sealing two of the three inlets at a time is proposed herein. The latter installation is characterized in that the sealing valve mechanism comprises a first one-sided shutter having a single sealing face and a second one-sided shutter having a single sealing face, each shutter being dedicated to and cooperating with a different pairing of two of the three valve seats. In other words, the sealing valve mechanism is configured to bring the sealing face of the first one-sided shutter into sealing contact in turn with each of the first and second valve seats whereas it is configured to bring the sealing face of the second one-sided shutter into sealing contact in turn with each of the second and third valve seats.

As will be appreciated, a lower sealing valve assembly as proposed hereinabove and defined herein is particularly suitable for industrial application in multiple hopper shaft furnace charging installations, especially top charging installations for blast furnaces. This lower sealing valve assembly can be used for constructing new installations or in retrofitting for replacing prior art assemblies e.g. during the cause of furnace refurbishment.

### BRIEF DESCRIPTION OF THE DRAWINGS

Preferred embodiments of the invention will now be described, by way of example, with reference to the accompanying drawings, in which:

FIG. 1 is perspective view of a first embodiment of a lower sealing valve assembly for a shaft furnace charging installation that has two hoppers, showing the assembly in a position in which a first inlet of a sealing valve housing is sealed and a second inlet is open;

FIG. 2 is perspective view showing the assembly of FIG. 1 in an intermediate position in which a shutter is being moved from a sealing engagement at the first inlet into sealing engagement at the second inlet;

FIG. 3 is perspective view showing the assembly of FIG. 1 in a position in which the first inlet of the sealing valve housing is open and the second inlet is sealed.

FIG. 4 is a partial diagrammatic horizontal projection of the sealing valve assembly of FIGS. 1-3;

FIG. 5 is perspective view illustrating a second embodiment of a lower sealing valve assembly to be used in a charging installation on a shaft furnace;

FIG. 6 is a partial top view of the valve actuation mechanism used in the second embodiment as illustrated in FIG. 5;

FIG. 7 is a partial side view of the valve actuation mechanism used in the second embodiment as illustrated in FIG. 5;

FIG. 8 is perspective view illustrating a third embodiment of a lower sealing valve assembly to be used in a charging installation on a shaft furnace;

FIG. 9 is a partial front view of the valve actuation mechanism used in the third embodiment as illustrated in FIG. 8;

FIG. 10 is a partial side elevation of the valve actuation mechanism used in the third embodiment as illustrated in FIG. 8;

FIG. 11 is a schematic top view of a fourth embodiment of a lower sealing valve assembly, which is designed for a shaft furnace charging installation that has three lock hoppers, showing the assembly in a position in which a first inlet and a second inlet of a sealing valve housing are sealed and a third inlet is open;

FIG. 12 is a schematic top view of a fifth embodiment of a lower sealing valve assembly, which is designed for a shaft furnace charging installation that has three lock hoppers, showing the assembly in a position in which a first inlet and a second inlet of a sealing valve housing are sealed and a third inlet is open;

FIG. 13 is a schematic top view of a sixth embodiment of a lower sealing valve assembly, which is designed for a shaft furnace charging installation that has three lock hoppers;

FIG. 14 is partial vertical sectional view of a prior art two-hopper charging installation as described e.g. in WO 2007/082630.

Identical reference signs have been used to identify identical or similar elements throughout these drawings. Reference signs with incremented hundreds digits have been used to identify structurally or functionally identical or similar parts of different embodiments of the invention.

### DETAILED DESCRIPTION

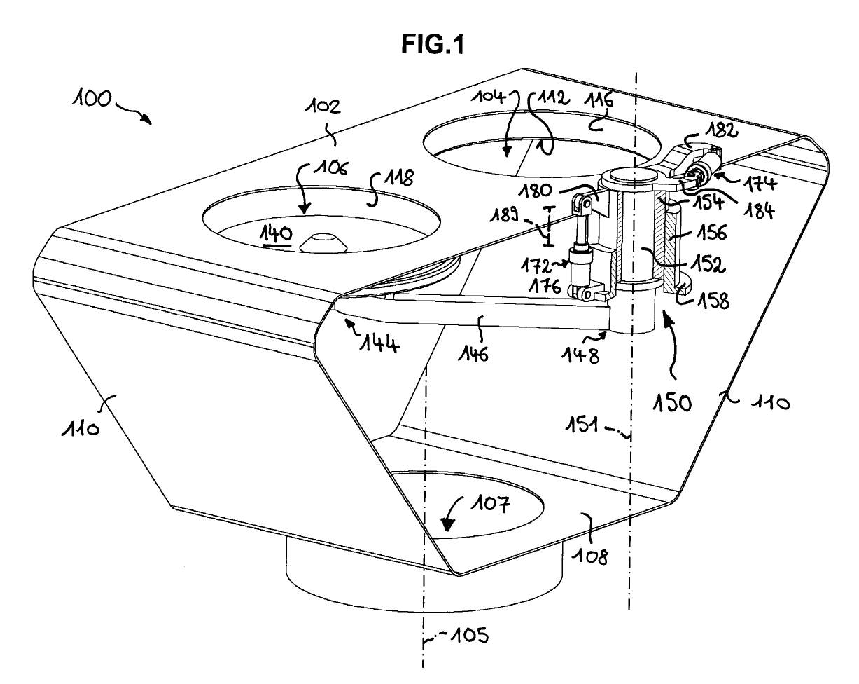

A charging installation with a lower sealing valve assembly according to a first embodiment is schematically shown in FIGS. 1-3. It comprises a lower sealing valve housing 100. For illustration purposes, the housing 100 is shown cut open, i.e. only partially, namely without lateral portions. The housing 100 has a horizontal top plate 102 with circular openings respectively forming a first inlet 104 and a second inlet 106. The inlets 104, 106 are laterally offset with respect to the central axis 105 of the blast furnace (which is not shown) on top of the throat of which the housing 100 is arranged. A lower outlet 107 is provided coaxially on the axis 105 in the form of a circular opening in a horizontal bottom plate 108 of the housing 100. Inclined side-walls 110 connect the top plate 102 to the bottom plate 108 and confer a generally funnel-shaped configuration to the housing 100 for passing a flow of charge material entering at either of the offset inlets 104, 106 along the slanting side-walls 110 to the central outlet 107.

As will be understood, the lower sealing valve assembly according to the first embodiment schematically shown in FIGS. 1-3 is configured for a blast furnace charging installation with two parallel hoppers (of the type as shown in FIG. 14). When installed on site, the housing 100 is arranged below two charge material hoppers of a charging installation of the type illustrated in FIG. 14 and described in more detail e.g. in WO 2007/082630. The hoppers serve as lock hoppers providing intermediate storage of charge material. When the lower sealing valve assembly is installed, the upper inlets 104, 106 are respectively connected to a hopper outlet (see FIG. 14) to which respective material gate valves (see FIG. 14) are associated for metering charge material. The outlet 107 of the funnel shaped housing 100 is to be arranged coaxially on top of the furnace throat (not shown) for passing charge material in free descent through the outlet 107 onto a distribution device such as, for example a rotatable and pivotable chute (not shown) of well known configuration. As will also be understood, in addition to centering the charge material flow, the housing 100 is a gas-tight enclosure that serves as a protective housing of the lower sealing valve assembly.

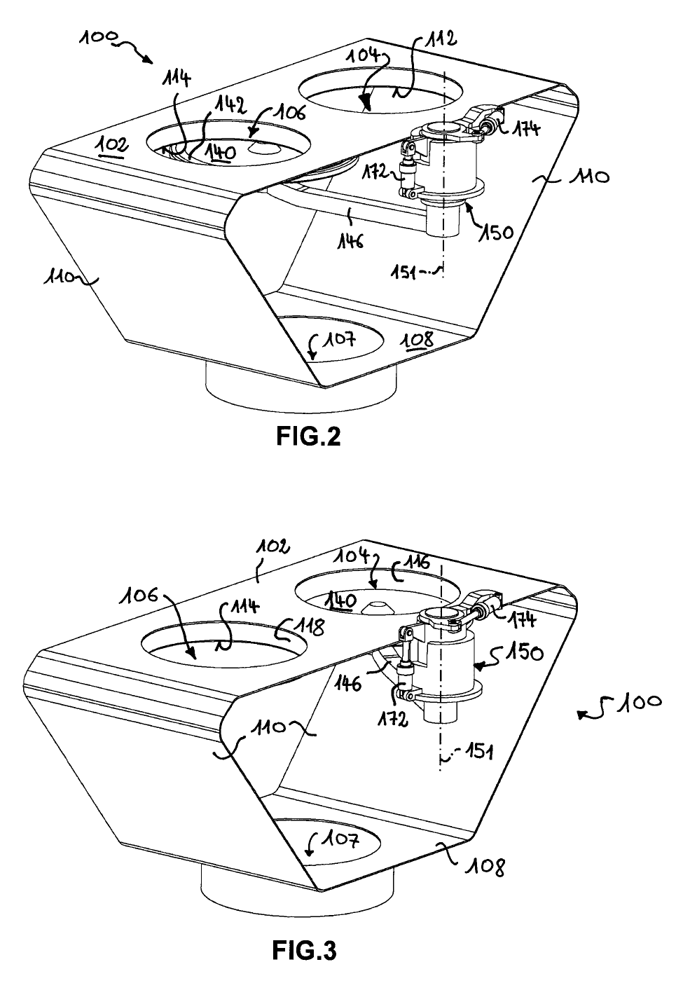

As seen in FIGS. 1-3, each inlet 104, 106 has a respective associated annular valve seat 112, 114, which is turned inwards to face the interior of the housing 100 and hence accessible from below. Each valve seat 112, 114 is provided on the downward face of a cylindrical rim 116, 118 that forms an extension of the inlets 104, 106 into the housing 100. The first and second valve seats 112, 114 shown in FIGS. 1-3 have annular seat surfaces oriented horizontally. Other orientations are also possible, e.g. slightly inclined as shown in FIG. 14. For leak-tight closure of the inlets 104, 106, the assembly comprises sealing valve mechanism formed by a shutter 140 and a valve actuation mechanism, as detailed hereinafter, for engaging the shutter 140 with the valve seats 112, 114. The shutter 140 is generally disk-shaped or plate-shaped shutter 140 and cooperates with both valve seats 112, 114. The shutter 140 is shown in sealing position on the second valve seat 114 in FIG. 1. For sealing contact, an annular seal 142 (seen in FIG. 2) is provided by means of a suitable seal, e.g. a rubber gasket, on the circumference of the shutter 140 on one side of the shutter 140 only. In this respect, the shutter 140 is termed a one-sided shutter that has a single sealing face. The seal 142 is conjugated to the seals of the valve seats 112, 114 for gas-tight closure by suitable sealing, e.g. rubber-metal sealing.

The shutter 140 is mounted on the tip of a first end portion 144 of an extension arm 146 by means of a globe joint (ball-and-socket joint, not shown). The globe joint warrants a circumferentially tight fit between the seal 142 and the surfaces of the seats 112, 114 and allows obtaining a leak-tight seal even with orientations of the valve seats 112, 114 that differ (e.g. inclined) from exactly horizontal. The rigid extension arm 146 has a second end portion 148 rigidly attached to the output member of a turn-slide cylindric joint 150 (C-joint) which will be detailed below. As seen in FIGS. 1-3, the extension arm 146 of the first embodiment is rigid and made of one-piece, i.e. devoid of articulations in between its end portions 144, 148.

As seen in FIGS. 1-3, the valve actuation mechanism comprises a turn-slide cylindric joint 150 that has a substantially vertical joint axis 151 and supports the extension arm 146. The cylindric joint 150 is shown in partial sectional view in FIG. 1. It is called cylindric or C-joint because trajectories traced by any point in the driven body, i.e. the arm 146 combined with the shutter 140, lie on cylinders about the joint axis 151. As will be understood, the cylindric joint 150 provides the kinematic equivalent of a revolute joint (R) combined with a prismatic joint (P) both sharing the same joint axis 151. Due to the vertical joint axis 151 of the cylindric joint 150, the rigid extension arm 146 and the shutter 140 can translate in unison up and down in a direction parallel to the joint axis 151, i.e. in substantially vertical direction. Furthermore, due the vertical joint axis 151 of the cylindric joint 150, the extension arm 146 together with the shutter 140 can swivel in a plane perpendicular to the joint axis 151, i.e. a substantially horizontal plane.

As seen in the partial sectional view of FIG. 1, the cylindric joint 150 includes an output shaft 152, i.e. a driven shaft, forming the output member of the cylindric joint 150, to which the extension arm 146 is rigidly attached so as to extend in generally horizontal direction transversely to the output shaft 152 and to the joint axis 151. The output shaft 152 forms the swivel supporting the extension arm 146 and the shutter 140. The output shaft 152 is coaxially supported in the cylindrical hollow space of a sleeve 154 in a manner fixed in axial direction and rotatable about the joint axis 151, e.g. by means of tapered roller bearings (not shown) or any other type of combined radial and axial load roller bearing. The sleeve 154 in turn is supported coaxially in the generally cylindrical hollow space of an outer shell 156 in axially slideable but rotatably fixed manner, i.e. so as to be slideable along the joint axis 151, e.g. by means of slide bearings. In an alternative to the cylindric joint 150 of FIG. 1, in which the rotation axis defined by the sleeve 154 and the translation axis defined by the shell 156 coincide with the joint axis 151, the parallel rotation and translation axes could be in series without necessarily being coincident. The outer shell 156 has a lower mounting flange 158. The outer shell 156 is mounted outside of the housing 100 with the mounting flange attached on top of the top plate 102 such that only the lower portion of the output shaft 152 protrudes inside the valve housing 100 through a circular opening (not shown) in the top plate 102. Consequently, except the shutter 140, the extension arm 146 and the lower end portion of the output shaft 152, all parts of the mechanism are arranged outside the housing 100 in the embodiment of FIGS. 1-3. In order to prevent gas leakage through the cylindric joint 150, seals are provided respectively between the output shaft 152 and the sleeve 154 and between the sleeve 154 and the shell 156, e.g. in form of a stuffing box or mechanical packing type seal (not shown).

As seen in FIGS. 1-3, the valve actuation mechanism includes linear hydraulic motors, namely a first hydraulic cylinder 172 and a second hydraulic cylinder 174, for operating the valve. The cylinder barrel of the first hydraulic cylinder 172 is connected by a hinge to a stationary lug 176 fixed to the lower end of the shell 156 whereas the piston head of the first hydraulic cylinder 172 is connected by a hinge to a moveable lug 180 fixed to the upper end portion of the sleeve 154. Pushing or pulling thrust of the first hydraulic cylinder 172 controls axial translation of the sleeve 154 and the output shaft 152 along the joint axis 151 and consequently also controls the upward or downward sliding motion of the shutter 140 attached to the rigid extension arm 146. The second hydraulic cylinder 174 controls rotation of the output shaft 152 relative to the sleeve 154 and the shell 156 about axis 151, i.e. horizontal swiveling of the shutter member 140 which is rigidly attached to the output shaft 152 via the extension arm 146. The second hydraulic cylinder 174 has its cylinder barrel hinged to a support arm 182 attached transversely to the upper end of the sleeve 154 and its piston head hinged to a lever arm 184 that is flange-mounted or clamped transversely to the upper end of the output shaft 152.

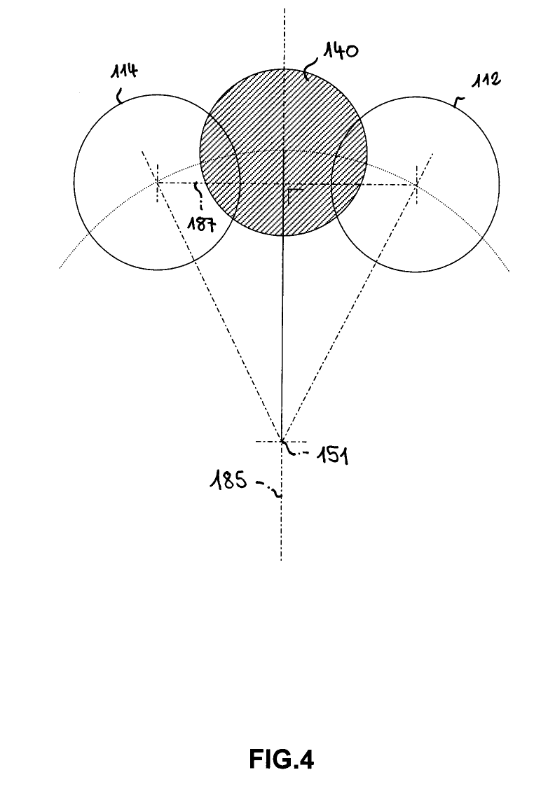

Referring to the diagrammatic plan view of FIG. 4, it will be appreciated that the joint axis 151 (which is perpendicular to the plane of FIG. 4) is contained in the perpendicular bisecting plane 185 (which is also perpendicular to the plane of FIG. 4) of the first and second valve seats 112, 114. More specifically, it is contained in the perpendicular bisecting plane 185 of an imaginary line segment 187 the end-points of which coincide with the centers of the valve seats 112, 114. As further seen in FIG. 4, the reach of the extension arm (146 in FIGS. 1-3), i.e. the distance between the axis 151 and the mounting axis of the shutter 140, is equal to the distance between the centers of the valve seats 112, 114 and the joint axis 151. In other words, when the shutter 140 is swiveled horizontally, the center of the shutter 140 travels on an arc of a circle, as indicated by a dotted arc in FIG. 4, having a radius equal to this distance. Although a vertical orientation of the joint axis 151 is preferable, slight inclinations, normally in the plane 185, with respect to the vertical e.g. up to 10° are possible. The sealing valve assembly enables the use of a one-sided shutter, i.e. a shutter with a single sealing face on one side only, that cooperates with both seats 112, 114 for alternatively sealing both inlets 104, 106. It will therefore be appreciated that, when charge material flows through the housing 100, the shutter 140 will always be in a closed position on either of the seats 112,114 and thus, especially its seal 142, protected from excessive dust deposits and material impacts. Although the joint axis could theoretically be place centrally between the valve seats 112, 114, this would require an actuation mechanism providing 180° angular swiveling motion and a certain amount of space between the seats 112, 114. Therefore, as seen in FIG. 4, the joint axis 151 is laterally offset from the line segment 187, which facilitates design of an actuation mechanism using a linear actuator for swiveling since only limited angular motion is required and allows decreasing the distance between the inlets 104, 106, e.g. to reduce outflow eccentricity downstream the lower outlet 107.

By virtue of the cylindric joint 150, the valve is operated in a lowering-swivelling-lifting motion sequence as shown from FIG. 1 to FIG. 3. FIG. 1 shows a configuration for a charging cycle using a first hopper above and communicating with the first inlet 104. In this configuration, the upper sealing valve on the first hopper (not shown) is closed, whereas the upper sealing valve on a second hopper (not shown), which communicates with the second inlet 106, is open for recharging the second hopper. When the first hopper has been emptied through the first inlet 104, the second inlet 106 is to be opened for emptying the second hopper and the first inlet 104 is to be sealed for refilling the first hopper. In this case, operation of the lower sealing valve is as follows: initially, both upper sealing valves (not shown) are closed, the first hydraulic cylinder 172 is then operated to contract (pull) and thereby lower the sleeve 154 and therewith, in unison, the output shaft 152, the extension arm 146 and the shutter 140, whereby the shutter 140 is disengaged from the second seat 114. Then the second hydraulic cylinder 174 is operated to expand (push) and thereby rotate the output shaft 152 about the joint axis 151 such that the extension arm 146 and the shutter 140 member swivel horizontally towards the first valve seat 112. When the shutter 140 is aligned with the first valve seat 112, e.g. due the second cylinder 174 reaching end-of-travel or due to an appropriate abutment or control, the first hydraulic cylinder 172 is operated to expand (push) and thereby lift the shutter 140 into sealing engagement with the first seat 112, as shown in FIG. 3. Thereby, the switching of the one-sided shutter 140 from the second seat 114 to the first seat 112 is achieved. The switching of the lock hopper function is then completed by opening the upper sealing valve of the first hopper for recharging. Operation as described above is reversed when the first inlet 104 is to be opened and the second inlet 106 is to be sealed. Due to a relatively small vertical travel 189 (compare FIGS. 1&2 or FIGS. 2&3) required for engaging/disengaging the shutter 140, the valve motion space requires only little vertical height. Hence, construction height of the housing 100 can be reduced significantly. It will further be understood, that the shutter member 140, except during its motion, will always be in a protected position on either of the seats 112, 114, when material passes through the housing 100.

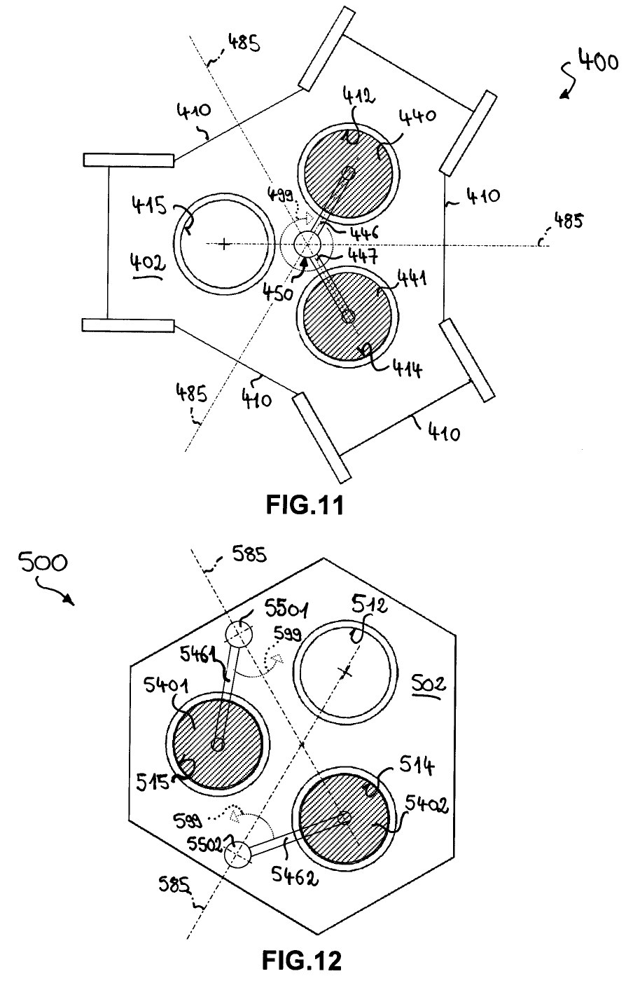

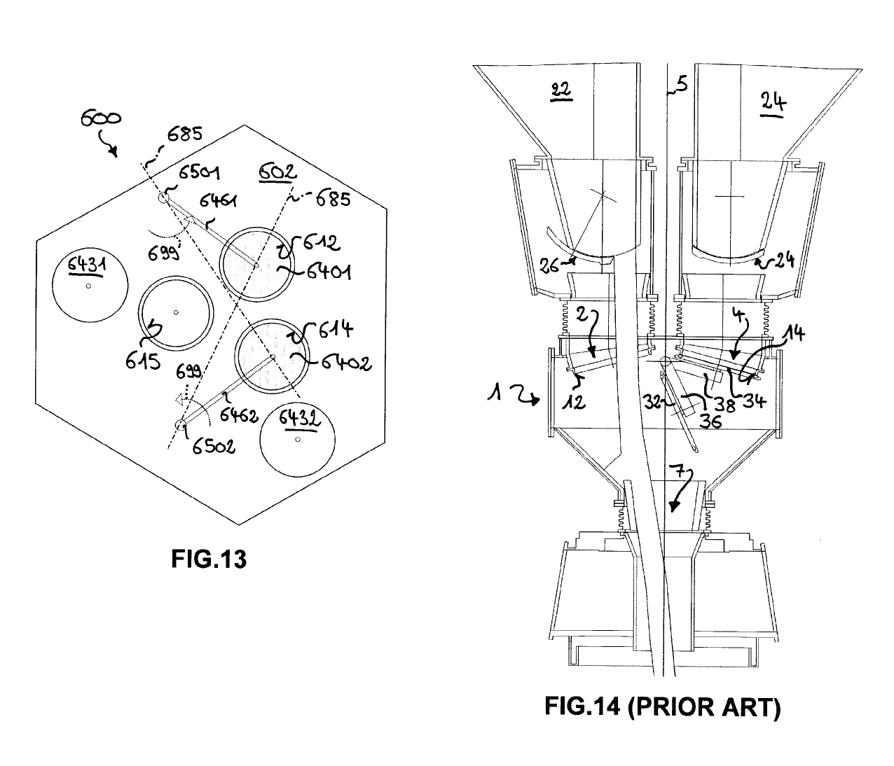

As will be appreciated, the above-described sealing valve mechanism which includes the actuation mechanism (itself composed of cylindric joint 150, actuators 172, 174 and cooperating accessories, the extension arm 146) and the shutter 140, is configured to bring the sealing face, i.e. that one side of the shutter 140 that bears the seal 142, into sealing contact alternatively with either of the two valve seats 112, 114 for sealing the associated inlet 104, 106.

Whereas the above sealing valve mechanism has been described by reference to a parallel hopper top with two hoppers, it can also be used in a three hopper top charging system using two sealing valve mechanisms as described above, one being associated to a first and a second inlet, and the other one being associated to the second and a third inlet of the lower sealing valve housing. Such an embodiment will be detailed further below with reference to FIG. 12. A comparable valve actuation mechanism can also be used in the embodiments of FIG. 11 and FIG. 13.

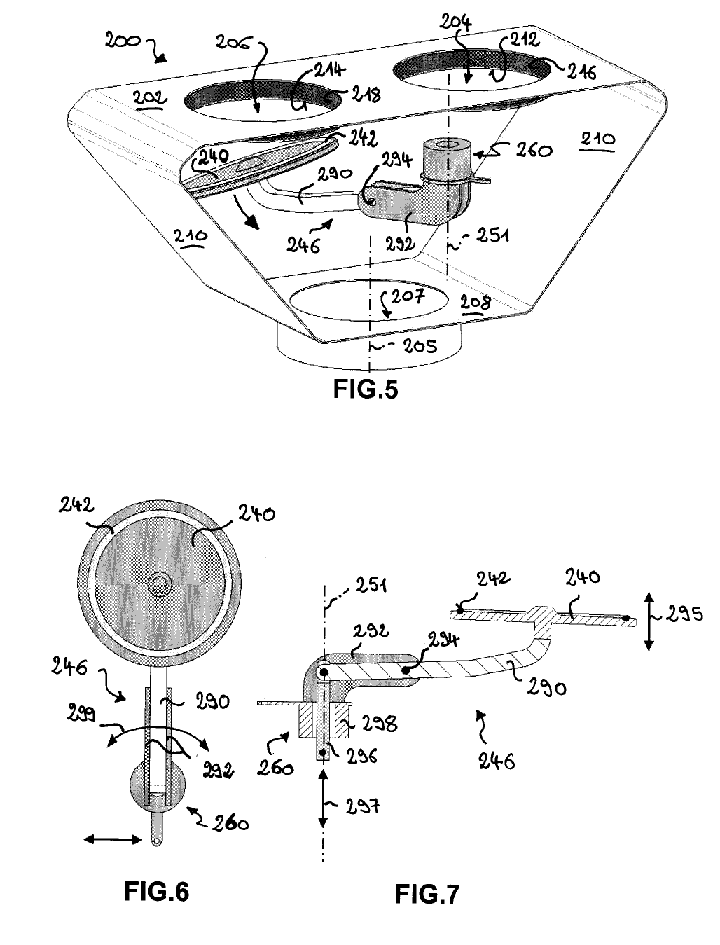

FIG. 5 schematically shows a second embodiment of a lower sealing valve assembly. Elements of the second embodiment that are identical or similar to those of FIGS. 1-3 are identified by reference numerals having identical tens and units digit but incremented hundreds digit in FIG. 5 and, for the sake of conciseness, will not be detailed again. The assembly illustrated in FIG. 5 has a sealing valve mechanism, and especially a valve actuation mechanism, which has a configuration different from that of FIGS. 1-3, as best illustrated in FIGS. 6-7.

As seen in FIGS. 6-7, the embodiment of FIG. 5 has a configuration that also allows swiveling the shutter 240 in a plane perpendicular to the joint axis 251, i.e. a substantially horizontal plane, whereas engaging and disengaging the shutter 240 with respect to the seats 212, 214 is effected by pivoting, instead of translating, the shutter 240 upwards and downwards.

For pivoting the shutter 240, the extension arm 246 of FIGS. 5-7 is not made rigid but made of two articulated parts that are connected by means of a horizontal hinge 294. More specifically, the extension arm 246 comprises a pivoting first part (forearm) 290 mounted pivotable about a horizontal axis on a second part (upper arm) 292 of the extension arm 246. Whereas the first part 290 is a substantially L-shaped bar, the second part 292 is a fork-shaped supporting frame made of two L-shaped plates, which acts as a support for the first part 290 that is pivotally mounted by means of the hinge 294. The hinge 294 has a horizontal hinge axis perpendicular to axis 251. As seen in FIGS. 5-7, the shutter 240 is mounted at the first end of the pivoting first part 290, more specifically by means of a globe joint (not shown). Accordingly, for bringing the shutter 240 into and out of contact with either of the seats 212, 214, the first part 290 is pivoted on the hinge 294 to move the shutter 240 up and down as indicated by double-arrow 295. In order to effect pivoting of the shutter 240 on the first part 290, the rear end of the first part 290 is jointed to an actuation rod 296 that is coupled to a linear actuator, such as a hydraulic cylinder (not shown in FIGS: 1-5) for pivoting the first part 290 by actuation along double-arrow 297. The actuation rod 296 passes through a hollow shaft 298, to which an end portion of the second part 292 of the extension arm 246 is fixed (e.g. welded). The hollow shaft 298 has a cylindrical outer surface and is mounted to be axially fixed but rotatable in a suitable bearing (not shown) supported on the top plate 202. The shaft 298 and its bearing (not shown) form a purely revolute joint 260 on joint axis 251, i.e. a joint that allows only rotation about vertical axis 251 (as opposed to C-joint 50 of FIGS. 1-3). Hence, the revolute joint 260 supports the extension arm 246 and thereby allows swiveling the second part 292 and therewith the first part 290 together with the shutter 240 in a substantially horizontal plane, as indicated by double-arrow 299 to position the shutter 240 below either of the seats 212, 214 as required (see FIG. 4). Actuation of the revolute joint 260 can be carried out by similar and appropriately adapted means as described with respect to the first embodiment (e.g. using a linear actuator) or by any other suitable drive arrangement known to the skilled person.

As will be understood, as an alternative to that of FIGS. 1-3, the sealing valve mechanism as illustrated in FIGS. 5-7 is also suitable for use in a three-hopper top charging installation according to FIG. 12 (see below).

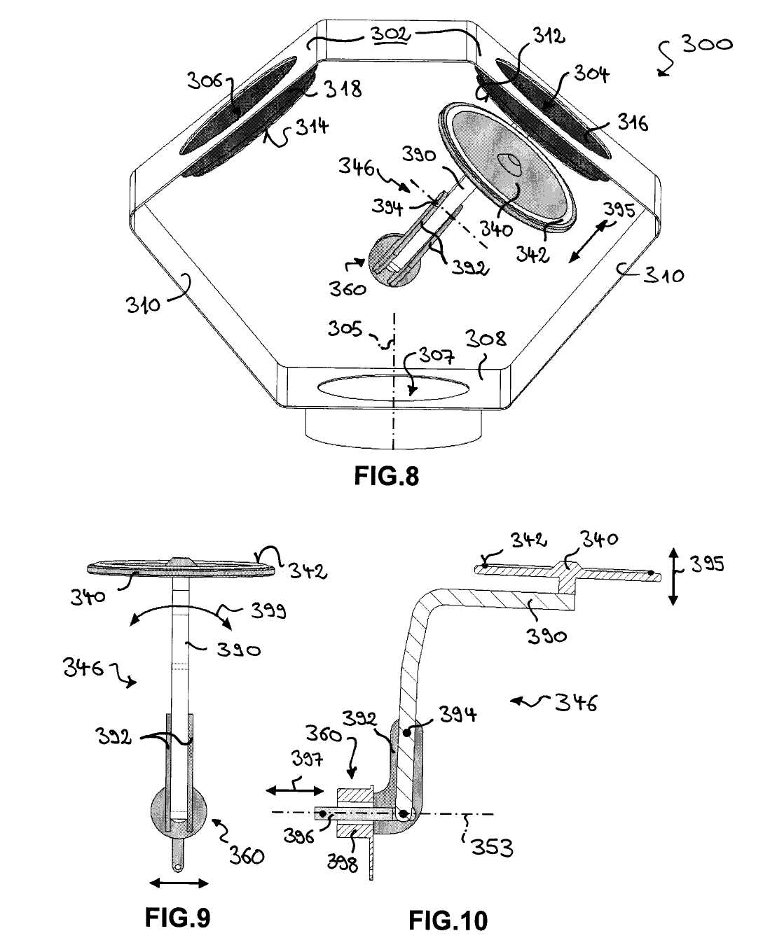

FIG. 8 schematically shows a third embodiment of a lower sealing valve assembly for use in a two-hopper charging installation. Elements of the third embodiment that are identical or similar in function to those of FIGS. 1-3 and FIGS. 8-10 respectively, are identified by reference numerals having identical tens and units digit but incremented hundreds digit in FIGS. 8-10. For the sake of conciseness, only elements that present a notable difference compared to the previous embodiments will be detailed below.

As appears from FIG. 8, the third embodiment is particularly suited for a sealing valve housing 300 of different design, namely a design in which a first and second valve seat 312, 314 are not generally horizontal nor slightly inclined, but substantially slanted (sloping) with respect to the horizontal, e.g. in the order of 35° (+/−10°). This type of design is currently in use on numerous blast furnaces and has been described in more detail elsewhere e.g. in U.S. Pat. No. 3,955,693. Accordingly, the top part 302 of the lower sealing valve housing in FIG. 8 has a generally half-hexagonal cross-sectional shape, with the openings 304, 306 provided in the sloping faces.

Therefore, the lower sealing valve assembly illustrated in FIG. 8 has a sealing valve mechanism, and especially a valve actuation mechanism, which is configured for slanted valve seats 312, 314. The configuration of the sealing valve mechanism of FIGS. 8-10 differs from that of FIGS. 1-3, but except for different axis orientations comparable to that of FIGS. 5-7, as best illustrated in FIGS. 9-10.

More specifically, the embodiment of FIGS. 8-10, like the embodiment of FIG. 5, has a configuration that also allows swiveling the shutter 340. In fact, as in FIGS. 5-7, engaging and disengaging the shutter 340 with respect to the seats 312, 314 is also done by pivoting in the third embodiment (instead of translating, the shutter upwards and downwards as in FIGS. 1-3). However, the shutter 340 is not swiveled in a horizontal plane as in FIGS. 5-7, but around a substantially horizontal joint axis 353. The shutter 340 thus swivels inside and along a horizontal cylindrical envelope defined by joint axis 353. Joint axis 353 is arranged so that the seats 312, 314 are generally tangent to this envelope.

Similar to the embodiment of FIG. 5, the extension arm 346 comprises a first part 390 that is hinge-mounted to a second part 392, which in turn is supported on the horizontal hollow shaft 398 of a pure revolute joint 360. The revolute joint 360 of FIGS. 8-10, as opposed to that of FIG. 5, presents a horizontal joint axis 353. Consequently, the revolute joint 360 of FIGS. 8-10 is not supported by the top part 302 but by a lateral generally horizontal sidewall of the lower sealing valve housing 300. Although oriented differently (at 90° with respect to the axis 151 and 251), the horizontal joint axis 353 in FIGS. 8-10 is also comprised in the perpendicular bisecting plane of the two valve seats 312, 314, which plane also comprises the furnace axis 305.

As seen in FIG. 10, the first part 390 is generally Γ-shaped, with the shutter 340 mounted transversely to a first end portion of the extension arm 346, e.g. by means of a globe joint (not shown), with the seal 342 facing upwards. Except for different orientation, the configuration of the second part 392 is identical to that of the second part 292 in FIGS. 5-7. Similar to FIG. 5, the extension arm 346 of FIG. 8 comprises a hinge 394 by means of which the first part 390 pivots with respect to the second part 392 to pivot the shutter 340 upwards and downwards along double-arrow 395. The hinge axis of the hinge 394 (dash-dotted line in FIG. 8) is perpendicular to the horizontal joint axis 353 but swivels with the extension arm 346 about the joint axis 353. Actuation of the extension arm is comparable to that described with respect to FIG. 5, the rear end of the first part 390 is jointed to an actuation rod 396 which is coupled to a linear actuator for actuation along double-arrow 397 to move the shutter 340 up and down along double-arrow 395. The horizontal hollow shaft 398, to which the second part 392 is fixed, is supported by a suitable bearing (not shown) to define the pure revolute joint 360 for swiveling the extension arm 346 and therewith the shutter 340 about the horizontal joint axis 353 and in accordance with double-arrow 399. Swiveling actuation can be provided by means of any suitable actuator arrangement, e.g. a linear arrangement comparable to that illustrated in FIG. 1.

FIG. 11 schematically shows a lower sealing valve assembly according to a fourth embodiment, which is designed for use in a three-hopper to charging installation of the type as disclosed e.g. in WO 2007/082630 (see FIGS. 5-9 of WO 2007/082630).

The assembly of FIG. 11 comprises three upper inlets each having an associated valve seat arranged inside the lower sealing valve housing 400, i.e. a first inlet with a first valve seat 412, a second inlet with a second valve seat 414 and a third inlet with a third valve seat 415. The inlets are arranged in the top plate 402 of the sealing valve housing 400 with the centers of the valve seats 412, 414, 415 (and inlets) disposed symmetrically around the furnace axis to form vertices of an imaginary equilateral triangle (in horizontal projection). The lower part of the sealing valve housing 400 may have a configuration as described in WO 2007/082630 (see reference sign 48′ in FIG. 9 of WO 2007/082630). The upper part however (as opposed to the upper part designated by reference sign 46′ in FIG. 9 of WO 2007/082630), has a different configuration. In particular, the upper portion of the sealing valve housing 400 comprises a sealing valve mechanism according to the present invention and sidewalls 410 arranged to provide the required space therefore in radial direction as seen in FIG. 11.

As seen in FIG. 11, the lower sealing valve mechanism includes two one-sided shutters, a first shutter 440 and a second shutter 441. The shutters 440, 441 are arranged on the tip end portion of respective extension arms 446, 447 which are rigidly connected at the opposite end portion. Hence, the arms 446, 447 form a two-pronged fork, with the prongs having a 120° corner angle adapted to fit the disposition of the valve seats 412, 414, 415. The valve actuation mechanism of FIG. 11 comprises a cylindric joint 450, to the output member of which the second end portions of the two extension arms 446, 447 are rigidly attached. As will be understood, the cylindric joint 450 is adapted to translate both extension arms 446, 447 and therewith the shutters 440, 441 up and down in a direction perpendicular to the plane of FIG. 11 for bringing them into and out of sealing engagement simultaneously with two of the three valve seats 412, 414, 415. As is further apparent from FIG. 11, the cylindric joint 450 is adapted to swivel the extension arms 446, 447 through 360° (full turn rotation), e.g. in clockwise direction, as indicated by arrow 499 to allow positioning the shutters 440, 441 relative to a set of two among the three valve seats 412, 414, 415. Accordingly, the valve actuation mechanism in FIG. 11 has a generally similar design to that of the FIG. 1, the notable differences being the use of a hydraulic motor or any other suitable drive (e.g. pneumatic or electric motor) capable of 360° output shaft rotation (instead of limited angular swiveling motion by means of a hydraulic cylinder), and the fact that two extension arms 446, 447 with two shutters 440, 441 are actuated simultaneously by means of a single actuation mechanism. The joint axis of the cylindric joint 450 is technically vertical and on the intersection of the perpendicular bisecting planes 485 of the pairings of the three valve seats 412, 414, 415 as shown in FIG. 11, i.e. perpendicular to the plane of FIG. 11 and passing through the circumcenter of the imaginary triangle (and coincident with the furnace axis in the illustrated embodiment).

As shall be noted, the sealing valve mechanism of FIG. 11 is configured to bring both sealing faces of the two shutters 440, 441 in paired manner and simultaneously into sealing contact in turn with each combinational pairing of the three valve seats 412, 414, 415. In other words, both shutters 440, 441 are actuated to alternatively seal the first and second valve seats 412, 414 (position shown in FIG. 11), the second and third valve seats 414, 415 and the third and first valve seats 415, 412. Hence, two of the three inlets are closed at a time, as required, while leaving one inlet open for charging purposes.

FIG. 12 shows a further fifth embodiment of a lower sealing valve assembly configured for a three-hopper shaft furnace charging installation. The embodiment of FIG. 12 comprises three inlets, each having an associated valve seat 512, 514, 515 arranged (as in FIG. 11) with their centers forming vertices of an equilateral triangle in the horizontal plane of FIG. 12, with the triangle circumcenter on the furnace axis.

To allow sealing each of the three inlets, the sealing valve mechanism according to FIG. 12 comprises a first valve actuation mechanism that is configured identical to that of FIG. 1, with a first cylindric joint 5501 bearing a first extension arm 5461 and thereon a first one-sided shutter 5401, and a second valve actuation mechanism configured identical to that of FIG. 1, i.e. with a second cylindric joint 5502 bearing a second extension arm 5462 with a second one-sided shutter 5402. Detailed description of the valve actuation mechanisms is given hereinabove, with reference to FIGS. 1-3. As seen in FIG. 12, the first valve actuation mechanism is associated with the pairing of third and first valve seat 515, 512 whereas the second valve actuation mechanism is associated with the second and third valve seats 514, 515. Accordingly, the first cylindric joint 5501 has its technically vertical joint axis arranged on the bisecting plane 585 of the first and third valve seats 512, 515 and the second cylindric joint 5502 has its joint axis arranged on the bisecting plane 585 of the second and third valve seats 514, 515.

As opposed to the embodiment of FIG. 11, that of FIG. 12 is configured to bring the first shutter 5401 into sealing contact alternatively with one of the first valve seat 512 and the third valve seat 515 only, and to bring the second shutter 5402 into sealing contact alternatively with one of the second and third valve seats 514, 515 only. Hence, the fifth embodiment provides another solution for sealed closure (of two at a time) of the three inlets in the lower sealing valve housing 500 using less than three dedicated actuation mechanisms. By virtue of using two separate actuation mechanisms, each associated with only one pairing of the three inlets, the respective required angular travel for horizontally swiveling the respective shutter 5401, 5402 is limited (as indicated by arrows 599). Accordingly, the three-hopper embodiment of FIG. 12 enables use of the same valve actuation mechanism with linear actuators as used in a two-hopper charging installation of FIGS. 1-3.

FIG. 13 shows a sixth embodiment of a lower sealing valve assembly, which is similar to that of FIG. 12. The lower sealing valve housing 600 in FIG. 13 thus comprises three inlets with respective valve seats 612, 614, 615. The sealing valve mechanism, as in FIG. 12, comprises two shutters 6401, 6402, each shutter 6401, 6402 being mounted on a respective extension arm 6461, 6462 that is supported by means of a dedicated cylindric joint 6501, 6502 arranged with a vertical joint axis on the bisecting plane 685 of the pairing of seats 612-615; 614-615, to which the shutter 6401, 6402 is associated. The major difference of the embodiment of FIG. 13 with respect to that of FIG. 12 resides in that the lower sealing valve housing 600 is configured to include a respective additional parking position 6431, 6432 for each shutter 6401, 6402. Furthermore, to allow positioning each shutter 6401, 6402 in its parking position 6431, 6432, the actuation mechanism design, although generally similar to that described above with respect to FIG. 1, is modified to include extension arms 6461, 6462 of greater length or to provide a greater swiveling range, i.e. a larger angular range of the swiveling motion, which is indicated by arrows 699. A combination of both types of modification of the actuation mechanism of FIG. 1 can also be envisaged. The parking positions 6431, 6432 are provided underneath the top plate 602 at an outward location, with their center located on the circular arc of swiveling motion (see FIG. 4) of the respective shutter 6401, 6402.

The parking positions in the embodiment of FIG. 13 allow opening two inlets at the same time for charging bulk material from two hoppers simultaneously, e.g. for mixing purposes. For instance, with the example configuration as shown in FIG. 13, besides the burden currently discharged from the hopper above the open third valve seat 615, additional charge material can be charged from the hopper above the second valve seat 614 (shown closed in FIG. 13), by moving the second shutter 6402 outwardly to its associated second parking position 6432. Similarly, burden from both hoppers above the first and second valve seats 612, 614 can be charged simultaneously with the first shutter 6401 in its parking position 6431 and the second shutter 6402 closing the third valve seat 615 or simultaneously from both hoppers above the first and third valve seats 612, 615 with the first shutter 6401 in its parking position 6431 and the second shutter 6402 closing the second valve seat 614. As will be appreciated, the parking positions 6431, 6432 are configured as pseudo-seats having no sealing function, which the sealing faces of the one-sided shutters 6401, 6402 engage in parked position to avoid exposure of the sealing faces also when two inlets are opened as enabled by the embodiment of FIG. 13.

1. A charging installation for a shaft furnace, in particular for a blast furnace, said installation comprising:
at least two hoppers for intermediate storage of charge material to be charged into the furnace, and
a lower sealing valve assembly comprising
a lower sealing valve housing that is arranged below said hoppers and has at least two inlets, each inlet having a respective associated valve seat and each inlet communicating with one of said hoppers respectively, and an outlet for passing charge material into the furnace; and
a sealing valve mechanism for sealing said inlets;
wherein
said sealing valve mechanism comprises a one-sided shutter having a single sealing face, said sealing valve mechanism being configured to bring said sealing face of said one-sided shutter into sealing contact in turn with each of said at least two valve seats for sealing the associated inlet.

2. The charging installation according to claim 1, wherein said sealing valve mechanism comprises:
a turn-slide cylindric joint having a substantially vertical joint axis and an extension arm having a first end portion and a second end portion, said shutter being mounted on said first end portion of said extension arm and said turn-slide cylindric joint supporting said extension arm at said second end portion,
for translating said shutter up and down in substantially vertical direction and swiveling said shutter in a substantially horizontal plane perpendicular to said joint axis to allow bringing said sealing face into sealing contact in turn with each of said at least two valve seats.

3. The charging installation according to claim 1, wherein said sealing valve mechanism comprises:
a revolute joint having a substantially vertical joint axis,
an extension arm having a first part with first end portion and a second part with a second end portion, said shutter being mounted on said first end portion of said first part and said revolute joint supporting said second part of said extension arm at said second end portion, and
a hinge having a substantially horizontal hinge axis and connecting said first part to said second part,
for swiveling said extension arm with said shutter in a substantially horizontal plane perpendicular to said joint axis and pivoting said first part with said shutter up and down about said substantially horizontal hinge axis to allow bringing said sealing face into sealing contact in turn with each of said at least two valve seats.

4. The charging installation according to claim 1, wherein said sealing valve mechanism comprises:
a revolute joint having a substantially horizontal joint axis,
an extension arm having a first part with first end portion and a second part with a second end portion, said shutter being mounted on said first end portion of said first part and said revolute joint supporting said second part of said extension arm at said second end portion, and
a hinge having a hinge axis arranged transversely to said joint axis, said hinge connecting said first part to said second part
for swiveling said extension arm with said shutter about said horizontal joint axis and pivoting said first part with said shutter up and down about said transverse hinge axis to allow bringing said sealing face into sealing contact in turn with each of said at least two valve seats.

5. The charging installation according to claim 2, wherein said cylindric joint comprises an output shaft, a hollow sleeve, in which said output shaft is supported axially fixed and rotatable about said joint axis, and an outer shell, in which said sleeve is supported axially slideable along said joint axis, said shell being fixed to said lower sealing valve housing.

6. The charging installation according to claim 5, wherein said sealing valve mechanism further comprises:
a first hydraulic cylinder connected to said shell and to said hollow sleeve for axially translating said hollow sleeve and said output shaft relative to said shell along said joint axis; and
a second hydraulic cylinder connected to said sleeve and to said output shaft for rotating said output shaft relative to said sleeve about said joint axis.

7. The charging installation according to claim 6, wherein
said first hydraulic cylinder has a cylinder barrel connected to said shell and a piston head connected to said hollow sleeve for axially translating said hollow sleeve and said output shaft relative to said shell along said joint axis;
said sleeve has a support arm attached transversely to an upper end portion of said sleeve, said output shaft has a lever arm attached transversely to an upper end portion of said output shaft, and
said second hydraulic cylinder has a cylinder barrel hinged to said support arm and a piston head hinged to said lever arm for rotating said output shaft relative to said sleeve about said joint axis.

8. The charging installation according to claim 1, wherein said sealing valve mechanism is supported by said lower sealing valve housing with said joint axis being contained in the perpendicular bisecting plane of two valve seats, with which said sealing face can be brought in turn into sealing contact.

9. The charging installation according to claim 2, wherein said sealing valve mechanism is supported by the top side of said lower sealing valve housing said housing with said substantially vertical joint axis laterally offset from the segment connecting the respective centers of said first valve seat and said second valve seat.

10. The charging installation according to claim 4, wherein said sealing valve mechanism is supported by a side wall of said lower sealing valve housing with said substantially horizontal joint axis vertically offset below the segment connecting the respective centers of said first valve seat and said second valve seat.

11. The charging installation according to claim 2, wherein said shutter is mounted on said first end portion of said extension arm by means of a globe joint.

12. A charging installation for a shaft furnace, in particular for a blast furnace, said installation comprising:
three hoppers for intermediate storage of charge material to be charged into the furnace, and
a lower sealing valve assembly comprising
a lower sealing valve housing that is arranged below said hoppers and has a first inlet with an associated first valve seat, a second inlet with an associated second valve seat, a third inlet with an associated third valve seat, each inlet communicating with one of said hoppers respectively, and an outlet for passing charge material into the furnace; and
a sealing valve mechanism for sealing said inlets;
wherein
said sealing valve mechanism comprises a first one-sided shutter having a single sealing face and a second one-sided shutter having a single sealing face, said sealing valve mechanism being configured to bring said sealing face of said first one-sided shutter and said sealing face of said second one-sided shutter respectively in paired manner into sealing contact in turn with said first and second valve seats, with said second and third valve seats and with said third and first valve seats so as to allow sealing two of said three inlets at a time.

13. A charging installation for a shaft furnace, in particular for a blast furnace, said installation comprising:
three hoppers for intermediate storage of charge material to be charged into the furnace, and
a lower sealing valve assembly comprising
a lower sealing valve housing that is arranged below said hoppers and has a first inlet with an associated first valve seat, a second inlet with an associated second valve seat, a third inlet with an associated third valve seat, each inlet communicating with one of said hoppers respectively, and an outlet for passing charge material into the furnace; and
a sealing valve mechanism for sealing said inlets;
wherein
said sealing valve mechanism comprises a first one-sided shutter having a single sealing face and a second one-sided shutter having a single sealing face, said sealing valve mechanism being configured to bring said sealing face of said first one-sided shutter into sealing contact in turn with each of said first and second valve seats and to bring said sealing face of said second one-sided shutter into sealing contact in turn with each of said second and third valve seats so as to allow sealing two of said three inlets at a time.

14. A lower sealing valve assembly for a shaft furnace charging installation with at least two hoppers, in particular for a blast furnace charging installation with at least two hoppers, said assembly comprising:
a lower sealing valve housing that is configured to be arranged below said hoppers and has at least two inlets, each inlet having a respective associated valve seat and each inlet being configured for communicating with one of said hoppers respectively, and an outlet for passing charge material to into the furnace; and
a sealing valve mechanism for sealing said inlets;
wherein
said sealing valve mechanism comprises a one-sided shutter having a single sealing face, said sealing valve mechanism being configured to bring said sealing face of said one-sided shutter into sealing contact in turn with each of said at least two valve seats for sealing the associated inlet.
